(19) United States
(12) Patent Application Publication
(10) Pub. No.: US 2009/0107944 A1
(43) Pub. Date: Apr. 30, 2009

(54) BEAM SAFETY CLIP AND BRACKET COMBINATION

(76) Inventor: Mark A. GOLDBERG, Lido Beach, NY (US)

Correspondence Address: DAVIDOFF MALITO & HUTCHER, LLP, 605 THIRD AVENUE, 34TH FL, NEW YORK, NY, 10158, US

(21) Appl. No.: 11/931,218

(22) Filed: Oct. 31, 2007

(51) Int. Cl. A47B 57/00; A47B 57/22; F16B 7/04

(52) U.S. Cl. 211/192; 248/220.21; 403/254

(57) ABSTRACT

A beam safety clip has a mounting clip secured in a recessed slot of a bracket and a locking pin biased into another recessed slot of the bracket such that the locking pin may be pulled clear of its recessed slot against bias while the mounting clip is blocked against its removal. Both recessed slots mirror each other within the bracket. An end of the mounting clip has two wings bent outward to enable grasping of same to pull the locking pin against spring bias out of the recessed slot that is in. Upon release, the locking pin biases back into the recessed slot from where it came. Each recessed slot includes a constricted portion and a non-constricted portion. The mounting clip is secured under bias to the constricted portion of one recessed slot while the locking pin is simultaneously biased into the non-constricted portion of the other recessed slot.

### BACKGROUND OF THE INVENTION

1. Field of the Invention

The present invention is directed to a beam safety clip secured to a bracket such that a locking pin of the beam safety clip may be urged against bias to pivot out of a non-constricted portion of a recess in the bracket while a mounting clip of the beam safety clip is blocked against its removal from a constricted portion of another recess.

2. Discussion of Related Art

U.S. Pat. No. 6,241,109 B1 reveals a load lock for a rack that includes a resilient mounting clip mounted in a recessed slot of the mounting bracket and that includes a locking pin having an enlarged head received in a further recessed slot of the mounting bracket. The locking pin can be retracted to install and remove the beam, but the recessed slot provides a stop to block the enlarged head from clearing the recessed slot so as to prevent the resilient mounting clip from retracting too far to damage the lock. Both recessed slots are arranged in the same relative orientation of constricted and non-constricted portions.

It is desired to provide a load lock or beam safety clip whose locking pin can be retracted to install and remove a beam, but will not be in a position to be blocked by a stop in the recessed slot, but rather urged to clear the recessed slot while the resilient mounting clip is pivoting. Preferably, the locking pin lacks an enlarged head. It is further desired that the slots be arranged to mirror each other in orientation as opposed to having the same orientation, while each has constricted and non-constricted portions.

### SUMMARY OF THE INVENTION

One aspect of the present invention resides in a beam safety clip and bracket. The beam safety clip has a resilient mounting clip secured in a recessed slot of the bracket and has a locking pin biased into another recessed slot of the bracket. The locking pin may be pulled against bias to clear the recessed slot even though the resilient mounting clip is blocked from doing so. Both recessed slots are arranged to mirror each other with respect to their placement within the bracket.

An end of the mounting clip has a handle portion in the form of two wings bent outward to enable grasping of same to pull the locking pin against spring bias out of the recessed slot that is in. Upon release, the locking pin biases back into the recessed slot from where it came.

Each recessed slot includes a constricted portion and a non-constricted portion. The mounting clip is secured under bias to the constricted portion of one recessed slot while the locking pin is simultaneously biased into the non-constricted portion of the other recessed slot.

The locking pin may have a shank whose diameter is too wide to fit within the constricted portion of the recessed slot.

### BRIEF DESCRIPTION OF THE DRAWING

For a better understanding of the present invention, reference is made to the following description and accompanying drawings, while the scope of the invention is set forth in the appended claims.

FIG. 1 is a front view of the beam safety clip secured to a bracket in accordance with the present invention.

FIG. 2 is a side view showing projection of a locking pin emerging out of a slot of a bracket in accordance with the present invention.

FIG. 3 is a rear view of the bracket secured to the beam safety clip in accordance with the present invention.

FIG. 4 is an enlarged view of a portion of FIG. 3.

### DETAILED DESCRIPTION OF THE PREFERRED EMBODIMENT

The contents of U.S. Pat. No. 6,241,109 are incorporated herein by reference as concerns attaching a beam to a vertical member and removing the beam from the vertical member. Storage racks generally include a plurality of vertical members, which rest on the floor, and a plurality of horizontal beams mounted on the vertical members. The beams include a mounting bracket with lugs projecting inwardly and downwardly from the bracket. The lugs are received in holes of the vertical members to support the weight of the horizontal beams. Load locks are commonly used to prevent the horizontal beams from becoming accidentally dislodged from the vertical members. The load locks generally include a locking pin, which extends through a slot in the bracket and a hole in the vertical member to prevent the horizontal beam from lifting up enough to dislodge the lugs.

First, a resilient locking member is brought adjacent to an outer surface of a first leg of the bracket, and a head of the locking pin is extended through the greater width portion of a first slot while the wings of the clip are extended through the greater width portion of the second slot. Then, the clip is flexed inwardly, and the resilient locking member is moved downwardly with the wings of the clip moving along the interior surface of the bracket until they pass a non-recessed portion and snap into a recess in the second slot. At the same time, the shank of the locking pin is moving down into the narrow part of the first slot. At this point, the locking member is mounted on the bracket. The wings in the recess prevent the locking member from moving out of the second slot unless the clip is again flexed inwardly to permit the wings to get over a ridge, which cannot occur when the bracket is mounted on the vertical member. When the clip is installed on the bracket, it is recessed so that it does not project inside the flat inner surface of the bracket. Each recess terminates short of its respective greater-width portion, leaving the ridge, which is a non-recessed, narrower-width portion.

Now, the assembled beam is mounted onto the vertical member, moving, toward the vertical member and then downwardly along the vertical member. Studs enter their respective vertical member holes. The body of the vertical member pushes the locking pin outwardly. The bracket moves downwardly until the locking pin reaches the vertical member hole. The resilience of the locking member body then pushes the locking pin inwardly into the hole. This then locks the beam onto the vertical member. The locking pin is located so that it is near the top of its respective hole when the studs are near the bottom of their respective holes. The locking pin thus prevents the beam from moving upwardly a sufficient distance to permit the studs to be removed from the vertical member. When the bracket is mounted on the vertical member, the body of the vertical member prevents the clip from flexing inwardly, so the resilient locking member cannot become dislodged from the bracket without first removing the beam from the vertical member.

In order to remove the beam from a vertical member, a person has to pull outwardly on a handle of a resilient locking member, retracting a locking pin to a position in which it is flush with the flat inner surface of a bracket, so the locking pin is removed from a recessed slot. A recessed surface in a constricted part of the recessed slot stops the head of the locking pin from coming completely out of the bracket, thereby preventing the operator from retracting the locking member far enough to damage it. Then, the bracket can be lifted up to a point at which studs can be removed from holes in the vertical member to remove the beam from the vertical member.

One can make some observations about the resilient locking member and the bracket of U.S. Pat. No. 6,241,109. The slots are arranged in the bracket in a uniform manner with the narrow (constricted) and wide portions of a recessed slot arranged in the same relative orientation as that of the other recessed slot. The shank of the locking pin is slid into the narrow portion of the recessed slot and the enlarged head at the end of the locking pin is blocked against removal from pulling outward too far while the shank remains situated in the narrow portion of the recessed slot.

The present invention does away with such constraints to provide more versatility. For instance, the beam safety clip of the present invention may be mounted to a bracket in accordance with the invention regardless of whether the locking pin is inserted into one slot or the other, as long as the orientation of the mounting clip in the companion slot is adjusted accordingly and secured to the applicable lug.

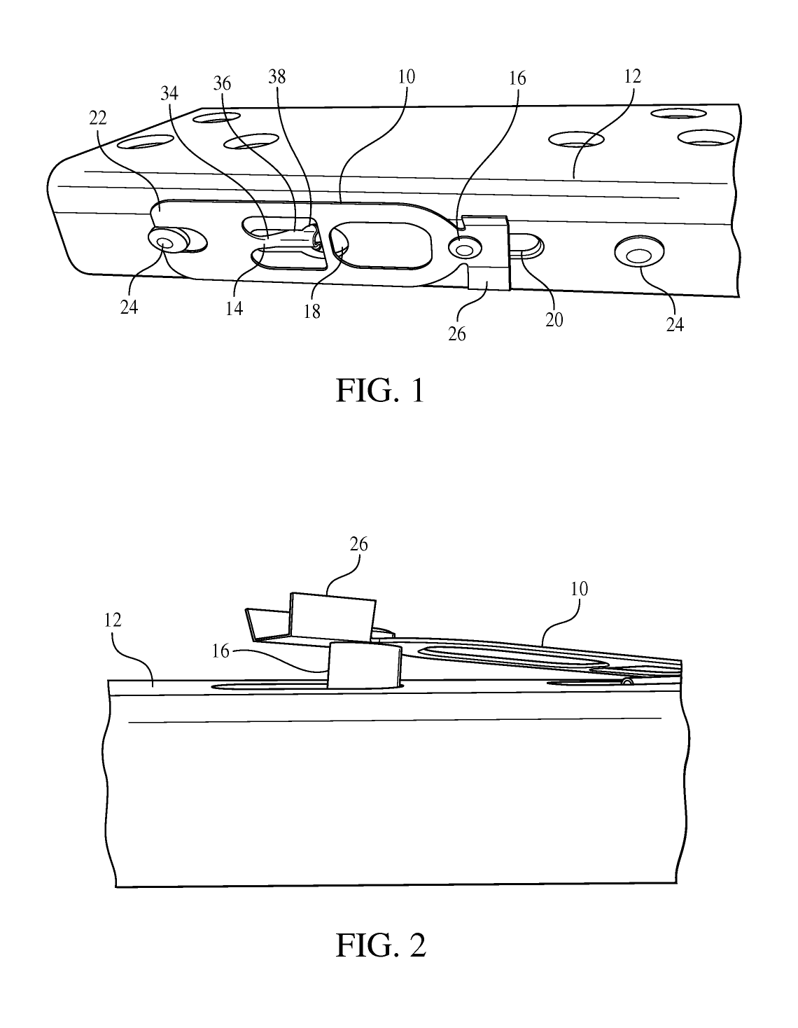

Turning to the drawing, FIG. 1 shows a beam safety clip 10 mounted to a bracket 12 in accordance with the invention. The beam safety clip 10 includes a resilient mounting clip 14 and a locking pin 16. The beam safety clip 10 is in effect a leaf spring. The bracket 12 includes two recessed slots 18, 20 that are configured and arranged to mirror each other within the bracket 12. The mounting clip 14 is mounted into the recessed slot 18 while the locking pin 16 biases into the recessed slot 20.

A C-shaped plate 22 rigidly secures an end of the beam safety clip 10 to a lug 24 that extends through a further opening in the bracket 12 close to one end of the bracket. An identical lug may be arranged through another opening close to the other end of the bracket 12. The opposite end of the safety beam clip 10 has a handle 26, which may have two outwardly bent flanges.

As shown in FIG. 2, by pulling the handle 26 against bias away from the bracket 12 so as to flex an end of the beam safety clip 10 to pivot, the locking pin 16 is pulled along with it and may be urged to clear the recessed slot 20 entirely. Upon release, the bias urges the locking pin to enter again into the recessed slot 20 by moving about the pivot.

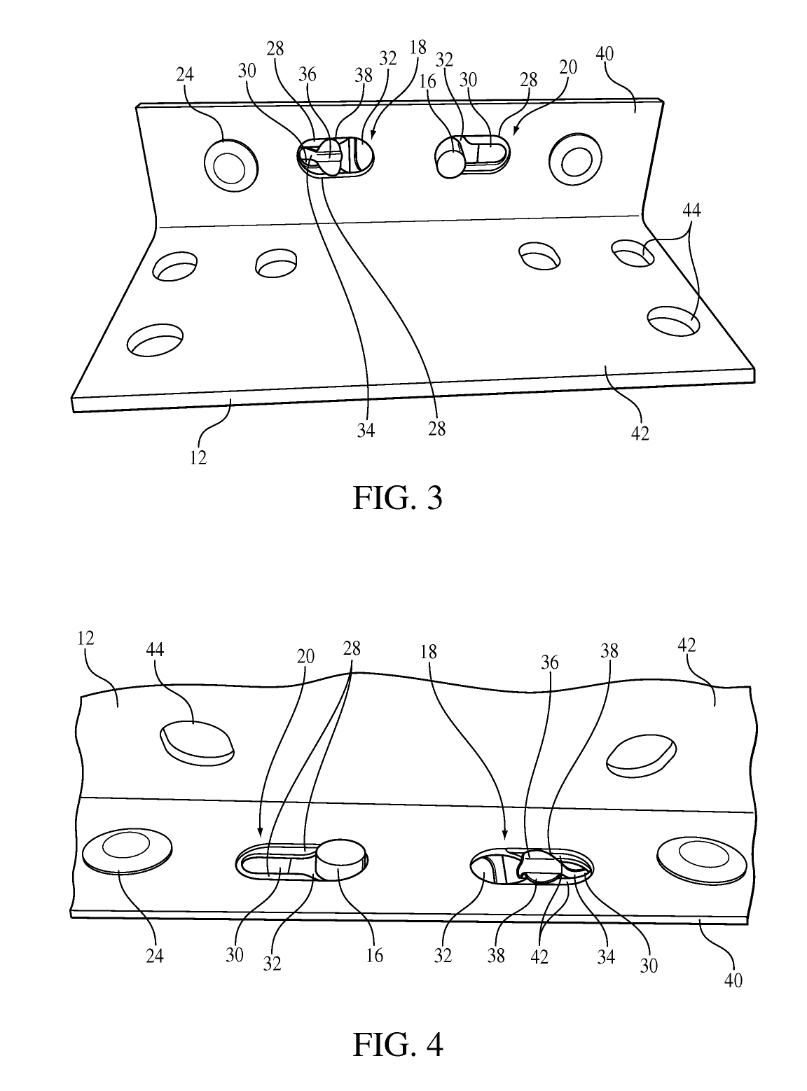

As shown in FIGS. 3 and 4, the locking pin 16 is a shank of uniform diameter. It needs no head of different diameter or an attached flange to stay in position. The bias afforded by the beam safety clip is sufficient to keep the shank of the locking pin 16 within the recessed slot 20.

Each slot 18, 20 has a respective recessed wall 28 that constricts the opening otherwise defined by the slot to define a constricted portion 30. The recessed walls protrude inwardly from an intermediate location along the depth of each respective slot 18, 20 to form ledges that define a stepped surface with a periphery of the depth. Each recessed wall 28 is U-shaped, with a curved portion connecting two prongs that terminate by tapering distally and outwardly so as to leave a non-constricted portion 32 in the remainder of the respective slot 18, 20. The non-constricted portion 32 may be circular in shape so as to have a diameter that is wider than the transverse distance defined across the constricted portion 30.

The mounting clip 14 includes an elongated tab 34 from which extends two stems 36 that pass through the constricted portion 30 of slot 18. The end of each stem 36 is bent to provide wings 38 that extend in opposite directions. Each wing 38 biases to rest in a recess upon a ledge of a respective prong of the U-shaped recess wall 28 of the slot 18. Since the wings 38 are in a recess, their outer surface may be flush with the bracket surface about the slot but not protrude outwardly.

There are apertures on both sides of the tab 34 that run the length of the tab 34. Such enables the frame of the mounting clip 10 to flex to some extent through pivoting.

The bracket 12 may be a L-bracket, with a narrow side 40 and a wide side 42 angled from each other from a bend. The slots 18, 20 may be in the narrow side 40. The wide side 42 may have a plurality of openings 44 arranged in a symmetric manner on either side as shown.

To form the beam safety clip 10, a conventional punch die may be used. The beam safety clip itself is preferably made of a metal that has resiliency. The mounting clip 14 is formed by punching recesses on either side of the step but retaining material to form the stems 36 and wings 38 by bending. The handle 26 is formed by cutting for shaping and by bending the wings outwardly. The slots 18, 20 in the bracket 12 may be hole punched or shaved to leave the recessed walls 28.

To mount, the beam safety clip 10 is positioned so that the wings 38 pass through the non-constricted portion 32 in the slot 18. The wings 38 are then slid over the ledge formed by the recessed wall 28 in the slot 18. In such a position, the locking pin 16 is free to enter under bias into the non-constricted portion of the slot 20. The end of the spring bias clip 10 is then secured to the C-shaped plate 24, which was previously secured to the lug 24.

Turning to FIGS. 1 and 2 for comparison, the beam safety clip 10 may be considered to have a proximal end (neighboring the mounting clip 14) that is secured to the lug 24 such as via the plate 22. Further, the beam safety clip 10 has a distal end, i.e., that has the handle 26. Thus, the locking pin 14 may be urged out of its non-constricted portion of the recessed slot 20 by pivoting the beam safety clip 10 about the proximal end by urging the distal end to move away from contact with the bracket 12, thereby forcing the locking pin 16 to move out of the non-constricted portion 32 of the recessed slot 20. Such occurs even though the mounting clip is blocked against its removal from the constricted portion 30 of the recessed slot 18 because of the wings 38 of the mounting clip 14 that are biased against the recessed wall 28 in the slot 18.

As can be appreciated, the short side 40 of the bracket 12 need only have the two slots 18, 20 that mirror each other in their orientation and an opening on either side to accommodate a lug 24. The slots 18, 20 may of the same dimension and have constricted and non-constricted portions. Thus, the beam safety clip 10 may be installed as shown in FIG. 1 or turned 180 degrees so that the plate 22 attaches to the other lug 24 and the locking pin 16 enters recessed slot 18 instead and the mounting clip 14 enters the recessed slot 20 instead.

As seen in the drawings, the beam safety clip 10 is an elongated leaf spring that has a frame with a proximal end and a distal end. The handle 26 projects from the distal end. The plate 22 is attached to the proximal end. The frame extend is in a plane and defines at least one aperture in which extends the mounting clip 14. The mounting clip 14 including a tab 34, two stems 36 extending out of the plane from the tab, two wings 38 each extending from a respective one of the two stems 36 at an angle from that of the stems. A locking pin 16 projects out of the plane from the frame at location neighboring the handle 26. The handle 26 extends in a direction transverse to a direction of elongation of the elongated leaf spring with opposite end portions extending out of the plane. The frame includes a further recess spaced between the recess and where the locking pin projects from the frame. The frame defines a periphery whose edge includes two portions substantially parallel to each other and two portions that symmetrically mirror each other to define a curvature that converges adjacent to where the locking pin projects from the frame to define a separation distance between. The handle 26 us wider than the separation distance. The locking pin 16 includes a shank of substantial cylindrical shape of uniform diameter that terminates into an end free of any head of a different diameter.

While the foregoing description and drawings represent the preferred embodiments of the present invention, it will be understood that various changes and modifications may be made without departing from the scope of the present invention.

What is claimed is:

1. In combination, comprising:
a bracket with two recessed slots spaced from each other and that are placed and configured to symmetrically mirror each other; each of the recessed portions having a constricted portion and a non-constricted portion that define openings of different dimensions; and
a beam safety clip having a mounting clip biased in the constricted portion of one of the recessed slots of the bracket to block removal of the mounting clip and having a locking pin biased into the non-constricted portion of a further recessed slot such that the locking pin may be urged clear of its recessed slot against bias by pivoting the beam safety clip even though the mounting clip is blocked under bias against removal.

2. The combination of claim 1, wherein the mounting clip has a proximal end secured to the bracket and a distal end with a handle to enable grasping of same to pivot the distal end about the proximal end so as to pull the locking pin against bias out of the non-constricted portion of the further recessed slot.

3. The combination of claim 2, wherein the beam safety clip has resiliency such that upon release of the handle when the locking pin is pulled out, the locking pin biases back into the non-constricted portion of the further recessed slot

4. The combination of claim 1, wherein each of the constricted portions is constricted by a respective structure that projects inwardly, each of the non-constricted portions being clear of the structure so as to be wider than the constricted portion.

5. A combination of claim 4, wherein the structure has a U-shape and forms a ledge that projects from an intermediate position along a depth of the periphery of the constricted portion so as to define a stepped surface.

6. A combination of claim 4 wherein the mounting clip includes wings that bias against the structure so that the structure blocks the removal of the mounting clip from the constricted portion of the one recessed slot at the same time that time that the locking pin may be urged against bias to clear the non-constricted portion of the further recessed slot.

7. A combination of claim 1, wherein the locking pin is constituted by a shank, the shank having a dimension that is too wide to fit within the constricted portion of the recessed slots.

8. A combination of claim 2, further comprising a lug secured to the bracket, the mounting clip being secured to the lug.

9. A combination of claim 8, further comprising a plate interposed between the lug and the proximal end of the mounting clip and securing both.

10. A combination of claim 1, wherein the mounting clip includes a tab, two stems extending from the tab, and two of the wings each bent to extend outward from a respective one of the two stems, the two stems projecting through the constricted portion of the one of the recessed slots.

11. A combination of claim 5, further comprising the U-shape has two prongs and a curvature connecting the two prongs that form the ledge.

12. A combination of claim 10, wherein each of the two prongs terminate by diverging distally and outwardly.

13. A combination of claim 2, wherein the handle includes two outwardly extending flanges each bent.

14. A beam safety clip, comprising:
an elongated leaf spring having a frame with a proximal end and a distal end, a handle projecting from the distal end, the frame extending in a plane and defining at least one aperture in which extends a mounting clip, the mounting clip including a tab, two stems extending from the tab out of the plane, two wings each extending from a respective one of the two stems at an angle from that of the stems; and
a locking pin that projects out of the plane from the frame a location neighboring the handle, the handle extending in a direction transverse to a direction of elongation of the elongated leaf spring with opposite end portions extending out of the plane.

15. A beam safety clip of claim 14, wherein the frame includes a further recess spaced between the first-mentioned recess and where the locking pin projects from the frame.

16. A beam safety clip of claim 14, wherein the frame defines a periphery whose edge includes two portions substantially parallel to each other and two portions that symmetrically mirror each other to define a curvature that converges adjacent to where the locking pin projects from the frame to define a separation distance between, the handle being wider than the separation distance.

17. A beam safety clip of claim 14, wherein the locking pin includes a shank of substantial cylindrical shape of uniform diameter that terminates into an end free of any head of a different diameter.

18. A bracket comprising:
a frame having two sides angled from each other with a bend between, one of the sides having two recessed slots each of substantially identical configuration but arranged in an orientation that symmetrically mirrors each other, and two apertures separated from each other with the recessed slots being situated between the two apertures, the other of the sides having a plurality of further apertures, the recessed slots each having a constricted portion and a non-constricted portion, the constriction portion being defined by a U-shape wall that projects inwardly from an intermediate location from a periphery of the recessed slot along a depth of the recessed slot to define a stepped surface.

19. A bracket of claim 18, wherein the further apertures include two groups arranged in a manner to symmetrically mirror each other.

20. A bracket of claim 18, further comprising a respective lug in each of the two apertures.
